(19) United States
(12) Patent Application Publication
(10) Pub. No.: US 2022/0288888 A1
(43) Pub. Date: Sep. 15, 2022

(54) A MOULDED PULP FIBRE PRODUCT, AND METHOD OF FORMING SAME

(71) Applicant: VARDEN PROCESS PTY LTD, Victoria (AU)

(72) Inventors: Mark APPLEFORD, Clayton, Victoria (AU); Stuart GORDON, Clayton, Victoria (AU)

(21) Appl. No.: 17/631,631

(22) PCT Filed: Jul. 30, 2020
(86) PCT No.: PCT/AU2020/050776

§ 371 Date: Jan. 31, 2022

(30) Foreign Application Priority Data
Jul. 30, 2019 (AU) 2019902722

(51) Int. Cl. B32B 5/12; B32B 3/06; B32B 37/14; B32B 37/06

(52) U.S. Cl. CPC B32B 5/12; B32B 3/06; B32B 37/144; B32B 37/06; B32B 2250/02; B32B 2250/03; B32B 2250/20; B32B 2439/70

(57) ABSTRACT

A moulded pulp fibre product and a method of forming a moulded pulp fibre product are provided. The method involves forming two or more pulp fibre pre-forms that each include at least one mating surface. Each pre-form is made from a suspension of pulp fibres in liquid. The pulp fibre pre-forms are assembled into a set in which adjacent pulp fibre pre-forms have mating surfaces that are in contact with, or adjacent to one another. The set of pulp fibre pre-forms are then bonded to form a pulp fibre laminate.

### FIELD OF THE INVENTION

The present invention relates to a moulded pulp fibre product. The present invention also relates to a method of forming a moulded pulp fibre product.

### BACKGROUND

Moulded pulp fibre is well known for use in packaging products, and single use food and beverage service trays/containers, and transport products. When made from products that can be recycled or otherwise composted after the product's useful life, moulded pulp fibre products can be “sustainable”, which is a highly desirable characteristic. In addition, moulded pulp fibre products can be less expensive to produce than equivalent products made of plastics materials.

A widely-utilized process (hereinafter referred to as the “basic process”) for forming moulded pulp fibre products involves:
1. creating a slurry of fibrous material and liquid in an open tank;
2. immersing a forming head into the slurry, the forming head having a shaped mesh mould;
3. applying suction to the forming head, so as to draw the slurry onto the mesh mould, whereby a wet pulp pre-form of the final moulded pulp fibre product is formed on the mesh mould;
4. removing the forming head from the open tank, while maintaining a suction pressure to hold the pre-form on the mesh mould;
5. releasing the wet pulp pre-form from the forming head, and
6. baking the wet pulp pre-form to remove water from the pulp, and thus form the final product shape.

A modified process for forming moulded pulp fibre products is known as “thermoforming”. This process involves applying heat and pressure to the wet pulp pre-form instead of the baking step of the basic process. The application of heat and pressure is achieved using a toolset of two (or more) complementary moulds that are heated, and pushed together with the pre-form disposed in the moulds to compress the wet pulp pre-form.

Products that are formed exclusively from moulded pulp fibre have limited applicability. This is at least in part due to the manner in which the wet pulp pre-form is created from the initial slurry.

It is known to make moulded pulp fibre products suitable for some applications by applying other materials, most commonly plastic films, to dry pulp fibre products. The result of these mixed material products is that the dissimilarity of the materials prevents, or at least inhibits, recycling or composting of the product.

There is a need to address the above, and/or at least provide a useful alternative process.

### SUMMARY

There is provided a method of forming a moulded pulp fibre product, the method involving:

forming two or more pulp fibre pre-forms that each include at least one mating surface, each pre-form being made from a suspension of pulp fibres in liquid;
assembling the pulp fibre pre-forms into a set in which adjacent pulp fibre pre-forms have mating surfaces that are in contact with, or adjacent to one another; and
bonding the set of pulp fibre pre-forms to thereby form a pulp fibre laminate.

The step of bonding the set of pulp fibre pre-forms can involve applying at least one of heat and pressure to the assembled set of pulp fibre pre-forms.

The step of bonding the set of pulp fibre pre-forms can involve creating mechanical bonds between adjacent pulp fibre pre-forms in the set.

Preferably, each mating surface is non-planar.

In some embodiments, the pulp fibre laminate formed by the method is the moulded pulp fibre product. In some alternative embodiments, the method further involves one or more processing steps on the pulp fibre laminate that result in formation of the moulded pulp fibre product.

The method can involve forming the pulp fibre pre-forms that are to be adjacent one another in the set with mating surfaces that fully complement one another.

The method can alternatively involve forming the pulp fibre pre-forms that are to be adjacent one another in the set with mating surfaces that only partially complement one another, and at least one of the assembling and bonding steps involves deforming at least one of the first and second pulp fibre pre-forms. In some embodiments, the deformation of at least one of the first and second pulp fibre pre-forms substantially eliminates cavities between the pre-forms.

The method can further involve creating two or more suspensions of pulp fibres in liquid, at least one of the pulp fibre pre-forms being formed of a first of the suspensions, and at least one of the pulp fibre pre-forms being formed of a second of the suspensions, and

wherein:
the pulp fibres used in each of the first and second suspensions are selected to have differing characteristics,
the liquid components of the first and second suspensions have differing substances dissolved and/or dispersed within the respective liquid component,
the liquid component of the first suspension and/or the second suspension includes substances that are not present in the liquid component of the other suspension, and/or
the first and/or second suspension has additives that alter the visual appearance of the respective lamina in the moulded pulp fibre product.

In embodiments in which the liquid components of the first and second suspensions have differing substances dissolved and/or dispersed within the respective liquid component:

substances within at least one of the suspensions undergo a chemical reaction with one another and/or with the pulp fibre component of the respective suspension, such that the laminae in the moulded pulp fibre product have differing properties; and/or
substances within at least one of the suspensions bond with the pulp fibres as the respective suspension dries, and wherein in the moulded pulp fibre product the solutes in the respective lamina contribute to the laminae in the moulded pulp fibre product having differing properties.

Preferably, for each pulp fibre pre-form, the forming step involves:

applying the suspension to a porous mould portion to form a slurry deposit on the mould portion; and
extracting fluid from the slurry deposit through the porous mould portion to form the pulp fibre pre-form.

In at least some embodiments, the steps of extracting fluid are such that, when assembling the pulp fibre pre-forms into the set, at least one of the pulp fibre pre-forms has a residual moisture content.

For each pulp fibre pre-form, the step of extracting fluid from the slurry deposit can involve any one or more of:

applying suction to the porous mould portion to draw fluid from the deposited slurry;
compressing the slurry deposit between opposing surfaces of a toolset to thereby squeeze liquid from the deposited slurry; and
heating the slurry deposit to thereby cause at least some liquid within the slurry deposit to change to gas.

Preferably, in embodiments in which fluid is extracted by compressing the respective slurry deposit, the slurry deposit is compressed in a toolset that includes two moulds that each define a respective one of two opposing surfaces that are shaped specifically for the respective pulp fibre pre-form.

In certain embodiments, for each pulp fibre pre-form, the step of extracting fluid from the slurry deposit can involve:

providing a press that includes the respective toolset;
transferring the slurry deposit from the porous mould portion to the toolset; and
compressing the slurry deposit between opposing surfaces of a toolset to thereby squeeze liquid from the deposited slurry.

Each toolset can include one or more heating elements associated with at least one of the respective moulds, and the method further involves transferring heat from the toolset to the respective slurry deposit simultaneously with the compressing step.

Alternatively or additionally, one or both of the moulds has pores that open onto the respective one of the opposing surfaces, and the method further involves extracting fluid from the respective slurry deposit by suction via the pores in the moulds.

Heating the slurry deposit can alternatively or additionally involve any one or more of: directing heated air towards the slurry deposit, exposing the slurry deposit to radiant heat, heating the porous mould toolset, and directing microwave and/or ultrasound energy towards the slurry deposit.

It will be understood that for the purposes of this specification and the claims that follow, “directing microwave and/or ultrasound energy towards the slurry deposit” will be understood to include putting a slurry deposit in an environment in which the slurry deposit is exposed to microwave and/or ultrasound energy, and passing a slurry deposit through an environment in which the slurry deposit is exposed to microwave and/or ultrasound energy.

In certain embodiments, for each pulp fibre pre-form, the step of extracting fluid from the respective slurry deposit can involve positioning a conformable material on the surface of that slurry deposit such that the slurry deposit is between the porous mould portion and the conformable material, and, when the conformable material is in contact with the slurry deposit, applying a pressure differential across the slurry deposit so as to draw the conformable material towards the porous mould portion and thereby squeeze the slurry deposit between the conformable material and the porous mould portion. A pressure differential across the slurry deposit may be achieved by application of suction to the porous mould portion, and/or application of positive pressure to the conformable material.

In some embodiments, the porous mould portion for each pulp fibre pre-form has a mould surface that defines a surface of the respective pulp fibre pre-form. In some embodiments, the surface of the pulp fibre pre-form that is defined by the mould surface corresponds with the respective mating surface of the pulp fibre pre-form. Alternatively, the mating surface of the respective pulp fibre pre-form is opposite to the surface that is defined by the corresponding mould surface.

The method can additionally involve incorporating one or more interstitial layers between two adjacent pulp fibre pre-forms in the set, wherein each interstitial layer is formed of material that has not been pulped. In some examples, the interstitial layer can have a shaped form corresponding with at least one surface that at least partially corresponds with one of the mating surfaces. Alternatively, the interstitial layer is formed in situ on one of the pulp fibre pre-forms. The material of the interstitial layer may include fibres. In some embodiments, the fibres are interconnected to distribute tensile stress from the pulp fibre through the interstitial layer in the pulp fibre laminate.

In some embodiments, the interstitial layers can be inserted between pulp fibre pre-forms prior to the assembling step. Alternatively, the interstitial layers can be inserted between pulp fibre pre-forms during the assembling step.

Some embodiments of the method can also involve applying one or more curable materials to at least one of the mating surfaces prior to the assembling step, the curable materials operating to form chemical bonds between adjacent pulp fibre pre-forms.

The curable material can be an adhesive that is applied to the respective mating surface. In some embodiments, the curable materials can include reactants that are applied to mating surfaces such that during the assembling and/or bonding steps the reactants are brought into contact with one another and undergo a chemical reaction, thereby curing and forming bonds between adjacent pulp fibre pre-forms.

In certain embodiments, the forming step for at least two adjacent pulp fibre pre-forms in the set involves forming a second of the adjacent pulp fibre pre-forms concurrently with the step of assembling the second of the adjacent pulp pre-forms with respect to the first of the adjacent pulp pre-forms.

There is provided a method of forming a moulded pulp fibre product, the method involving:

forming a first pulp fibre pre-form from a suspension of pulp fibres in liquid, the first pulp fibre pre-form including a first mating surface;
forming a second pulp fibre pre-form from a suspension of pulp fibres in liquid, the second pulp fibre pre-form including a second mating surface;
assembling the second pulp fibre pre-form with respect to the first pulp fibre pre-form, such that at least part of the first mating surface is in contact with, or adjacent to the second mating surface;
bonding the first and second pulp fibre pre-forms to one another, thereby forming a pulp fibre laminate.

The step of bonding the set of pulp fibre pre-forms can involve applying at least one of heat and pressure to the assembled first and second pulp fibre pre-forms.

The step of bonding the set of pulp fibre pre-forms can involve creating mechanical bonds between the first and second pulp fibre pre-forms.

Preferably, each mating surface is non-planar.

In some embodiments, the pulp fibre laminate formed by the method is the moulded pulp fibre product. In some alternative embodiments, the method further involves one or more processing steps on the pulp fibre laminate that result in formation of the moulded pulp fibre product.

The method can involve forming the first and second pulp fibre pre-forms such that the first and second mating surfaces fully complement one another.

The method can alternatively involve forming the first and second pulp fibre pre-forms with first and second mating surfaces that only partially complement one another, and at least one of the assembling and bonding steps involves deforming at least one of the first and second pulp fibre pre-forms. In some embodiments, the deformation of at least one of the first and second pulp fibre pre-forms substantially eliminates cavities between the pre-forms.

The assembling step can additionally involve incorporating one or more interstitial layers between the first and second pulp fibre pre-forms, wherein each interstitial layer is formed of material that has not been pulped. In some examples, the interstitial layer can have a shaped form corresponding with at least one surface that at least partially corresponds with one of the mating surfaces. Alternatively, the interstitial layer is formed in situ on one of the pulp fibre pre-forms. The material of the interstitial layer may include fibres. In some embodiments, the fibres are interconnected to distribute tensile stress from the pulp fibre through the interstitial layer in the pulp fibre laminate.

In some embodiments, the interstitial layers can be inserted between pulp fibre pre-forms prior to the assembling step. Alternatively, the interstitial layers can be inserted between pulp fibre pre-forms during the assembling step.

Some embodiments of the method can also involve applying one or more curable materials to at least one of the first and second mating surfaces prior to the assembling step, the curable materials operating to form chemical bonds between adjacent pulp fibre pre-forms.

The curable material can be an adhesive that is applied to the respective mating surface. In some embodiments, the curable materials can include reactants that are applied to the first and second mating surfaces such that during the assembling and/or bonding steps the reactants are brought into contact with one another and undergo a chemical reaction, thereby curing and forming bonds between the first and second pulp fibre pre-forms.

The method can further involve:

creating a first suspension of pulp fibres in liquid from which the first pulp fibre pre-form is formed, and
creating a second suspension of pulp fibres in liquid from which the second pulp fibre pre-form is formed,
wherein:
the pulp fibres used in each of the first and second suspensions are selected to have differing characteristics,
the liquid components of the first and second suspensions have differing substances dissolved and/or dispersed within the respective liquid component,
the liquid component of the first suspension and/or the second suspension includes substances that are not present in the liquid component of the other suspension, and/or
the first and/or second suspension has additives that alter the visual appearance of the respective lamina in the moulded pulp fibre product.

In embodiments in which the liquid components of the first and second suspensions have differing substances dissolved and/or dispersed within the respective liquid component:

substances within at least one of the suspensions undergo a chemical reaction with one another and/or with the pulp fibre component of the respective suspension, such that the laminae in the moulded pulp fibre product have differing properties; and/or
substances within at least one of the suspensions bond with the pulp fibres as the respective suspension dries, and wherein in the moulded pulp fibre product the solutes in the respective lamina contribute to the laminae in the moulded pulp fibre product have differing properties.

Preferably, the step of forming the first pulp fibre pre-form involves:

applying the first suspension to a first porous mould portion to form a first slurry deposit on the first mould portion; and
extracting fluid from the first slurry deposit through the first porous mould portion to form the first pulp fibre pre-form.

The step of extracting fluid from the first slurry deposit can involve any one or more of:

applying suction to the first porous mould portion to draw fluid from the deposited slurry;
compressing the first slurry deposit between opposing surfaces of a first toolset to thereby squeeze liquid from the deposited slurry; and
heating the slurry deposit to thereby cause liquid within the slurry deposit to change to gas.

In certain embodiments, the step of extracting fluid from the first slurry deposit can involve:

providing a press that includes the first toolset;
transferring the first slurry deposit from the first porous mould portion to the first toolset; and
compressing the first slurry deposit between opposing surfaces of a first toolset to thereby squeeze liquid from the deposited slurry.

The first toolset can include two moulds that each define a respective one of the opposing surfaces, and one or more heating elements associated with at least one of the moulds, and the method further involves transferring heat from the toolset to the first slurry deposit simultaneously with the compressing step.

Alternatively or additionally, one or both of the moulds has pores that open onto the respective one of the opposing surfaces, and the method further involves extracting fluid from the first slurry deposit by suction via the pores in the moulds.

Heating the first slurry deposit can alternatively or additionally involve any one or more of: directing heated air towards the first slurry deposit, exposing the first slurry deposit to radiant heat, heating the porous mould toolset, and directing microwave and/or ultrasound energy towards the first slurry deposit.

In certain embodiments, the step of extracting fluid from the first slurry deposit can involve positioning a conformable material on the surface of the first slurry deposit such that the first slurry deposit is between the first porous mould portion and the conformable material, and, when the conformable material is in contact with the first slurry deposit, applying a pressure differential across the slurry deposit so as to draw the conformable material towards the first porous mould portion and thereby squeeze the first slurry deposit between the conformable material and the first porous mould portion.

In some embodiments, the first porous mould portion has a mould surface that defines a surface of the first pulp fibre pre-form. In some embodiments, the surface of the first pulp fibre pre-form that is defined by the mould surface corresponds with the first mating surface. Alternatively, the mating surface of the first pulp fibre pre-form is opposite to the surface that is defined by the mould surface.

Preferably, the step of forming the second pulp fibre pre-form involves:

applying the second suspension to a second porous mould portion to form a second slurry deposit on the second mould portion; and
extracting fluid from the second slurry deposit through the second porous mould portion to form the second pulp fibre pre-form.

The step of extracting fluid from the second slurry deposit can involve any one or more of:

applying suction to the second porous mould portion to draw fluid from the deposited slurry;
compressing the second slurry deposit between opposing surfaces of a second toolset to thereby squeeze liquid from the deposited slurry; and
heating the slurry deposit to thereby cause liquid within the slurry deposit to change to gas.

In certain embodiments, the step of extracting fluid from the second slurry deposit can involve:

providing a press that includes the second toolset;
transferring the second slurry deposit from the second porous mould portion to the second toolset; and
compressing the second slurry deposit between opposing surfaces of a second toolset to thereby squeeze liquid from the deposited slurry.

The second toolset can include two moulds that each define a respective one of the opposing surfaces, and one or more heating elements associated with at least one of the moulds, and the method further involves transferring heat from the toolset to the second slurry deposit simultaneously with the compressing step.

Alternatively or additionally, one or both of the moulds has pores that open onto the respective one of the opposing surfaces, and the method further involves extracting fluid from the second slurry deposit by suction via the pores in the moulds.

Heating the second slurry deposit can alternatively or additionally involve any one or more of: directing heated air towards the second slurry deposit, exposing the second slurry deposit to radiant heat, heating the second porous mould portion, and directing microwave and/or ultrasound energy towards the second slurry deposit.

In certain embodiments, the step of extracting fluid from the second slurry deposit can involve positioning a conformable material on the surface of the second slurry deposit such that the second slurry deposit is between the second porous mould portion and the conformable material, and, when the conformable material is in contact with the second slurry deposit, applying suction to the second porous mould portion to draw the conformable material towards the second porous mould portion and thereby squeeze the second slurry deposit between the conformable material and the second porous mould portion.

In some embodiments, the second porous mould portion has a mould surface that defines a surface of the second pulp fibre pre-form. In some embodiments, the surface of the second pulp fibre pre-form that is defined by the mould surface corresponds with the second mating surface. Alternatively, the mating surface of the second pulp fibre pre-form is opposite to the surface that is defined by the mould surface.

In certain embodiments, the steps of forming the second pulp fibre pre-form occurs concurrently with the step of assembling the second pulp pre-form with respect to the first pulp pre-form.

There is also provided a moulded pulp fibre product comprising:

two or more lamina formed of dried pulp fibre materials that are assembled and bonded to form a pulp fibre laminate,
wherein, in the moulded pulp fibre product:
at least two of the laminae have pulp fibres with differing characteristics;
at least one of the lamina includes substances within the lamina that are bonded with the respective pulp fibres, the substances:
having been dissolved and/or dispersed within the liquid component of the suspension from which the lamina is formed, and
causing the respective lamina to have different properties to at least one other lamina in the moulded pulp fibre product; and/or
at least one of the lamina is formed from a suspension that includes additives causing the respective lamina to have a visually different appearance to at least one other lamina in the moulded pulp fibre product.

### BRIEF DESCRIPTION OF THE DRAWINGS

In order that the invention may be more easily understood, embodiments will now be described, by way of example only, with reference to the accompanying drawings, in which:

FIG. 1: is a flowchart of a method of forming a moulded pulp fibre product, the method being in accordance with a first embodiment of the present invention;

FIGS. 2 to 4: are schematic cross-sectional views of stages in one example of the method of FIG. 1;

FIGS. 5 to 7: are schematic cross-sectional views of stages in another example of the method of FIG. 1;

FIG. 8: is a flowchart of a method of forming a moulded pulp fibre product, the method being in accordance with a second embodiment of the present invention;

FIG. 9: is a flowchart of a method of forming a moulded pulp fibre product, the method being in accordance with a third embodiment of the present invention;

FIG. 10a: is a flowchart of a method of forming a moulded pulp fibre product, the method being in accordance with a fourth embodiment of the present invention;

FIG. 10b: is a flowchart of a variant of the method illustrated in FIG. 10a;

FIG. 11: is a flowchart of a method of forming a moulded pulp fibre product, the method being in accordance with a fifth embodiment of the present invention;

FIG. 12: is a flowchart of a method of forming a moulded pulp fibre product, the method being in accordance with a sixth embodiment of the present invention;

FIG. 13: is a vertical cross-sectional view of two pulp fibre pre-forms according to a third example, the pulp fibre pre-forms being assembled into a set;

FIG. 14: is a vertical cross-sectional view of two pulp fibre pre-forms according to a fourth example, the pulp fibre pre-forms being assembled into a set;

FIG. 15: is a vertical cross-sectional view of two pulp fibre pre-forms according to a fifth example, the pulp fibre pre-forms being assembled into a set; and

FIGS. 16 and 17: are schematic cross-sectional views of stages in another example of a method according to another embodiment of the present invention.

### DETAILED DESCRIPTION

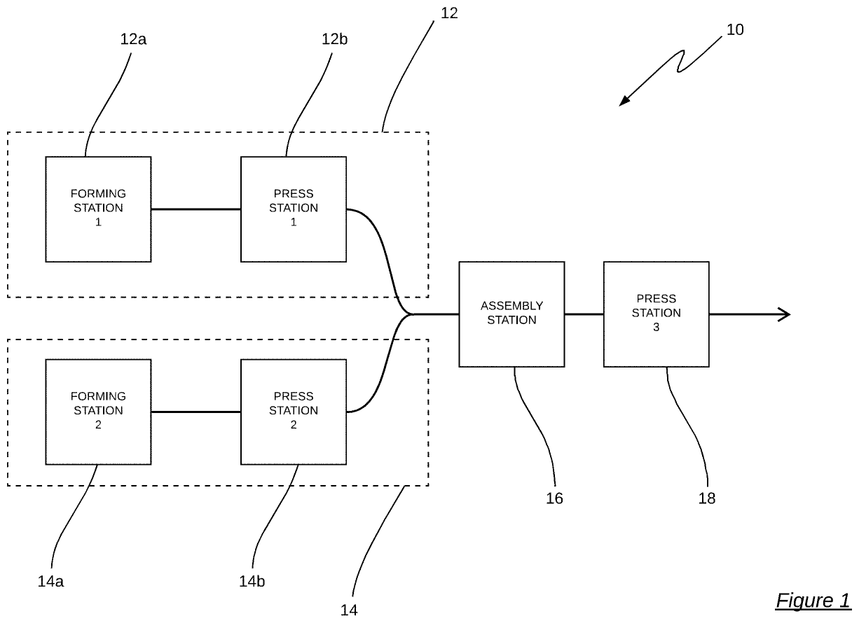

FIG. 1 is a flowchart illustrating a method 10 of forming a moulded pulp fibre product, the method 10 being in accordance with a first embodiment. The method 10 of this embodiment involves:
Forming a first pulp fibre pre-form from a suspension of pulp fibres in liquid, the first pulp fibre pre-form including a first mating surface—step 12.
Forming a second pulp fibre pre-form from a suspension of pulp fibres in liquid, the second pulp fibre pre-form including a second mating surface—step 14.
Assembling the first pulp fibre pre-form with respect to the second pulp fibre pre-form, such that at least part of the first mating surface is in contact with, or adjacent to the second mating surface—step 16.
Bonding the first and second pulp fibre pre-forms to one another, thereby forming a pulp fibre laminate—step 18.

In the method 10 illustrated in FIG. 1, forming step 12 involves two sub-steps 12a, 12b; in applying sub-step 12a, a first suspension of pulp fibres in liquid is applied to a first porous mould portion to form a first slurry deposit on the first mould portion; and in subsequent extracting sub-step 12b, fluid from the first slurry deposit is extracted through the first porous mould portion. In this way, the first pulp fibre pre-form is formed. Applying sub-step 12a can occur within a forming station—“Forming Station 1” in FIG. 1. Extracting sub-step 12b can involve application of pressure to the first slurry deposit within a mechanical press—“Press Station 1” in FIG. 1—that mechanically expels liquid from the slurry. Similarly, forming step 14 involves two sub-steps 14a, 14b that are each substantially similar to sub-steps 12a, 12b, respectively.

In assembling step 16, the two pulp fibre pre-forms are assembled, one onto/over the other—“Assembly Station” in FIG. 1. It will be appreciated that the particular action required in the assembling step will at least partly depend on the geometric and structural properties of the first and second pulp fibre pre-forms that are formed in forming steps 12, 14.

Further, bonding step 18 in this example involves application of at least pressure to the assembled first and second pulp fibre pre-forms in a press—“Press Station 3” in FIG. 1. The application of pressure can be augmented with heat to facilitate liberation of liquid from the pre-forms, and/or with suction to facilitate drawing of fluid from the pre-forms. Where the first and second mating surfaces (of the first and second pulp fibre pre-forms) are at least partly in direct contact with one another after the assembling step 16, the press of bonding step 18 creates mechanical bonds between fibres of the first and second pulp fibre pre-forms.

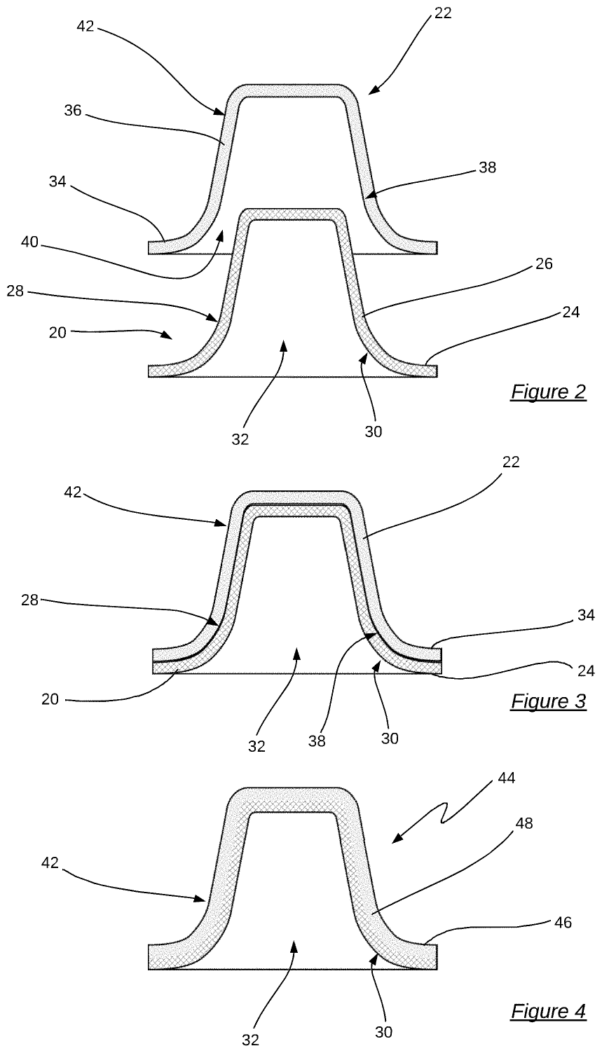

FIGS. 2 to 4 illustrate schematically stages in the method 10, according to a first example. In FIGS. 2 and 3, a formed first pulp pre-form 20 and a formed second pulp pre-form 22 are shown. The first pulp pre-form 20 has an annular flange 24 that extends around the rim of a bowl portion 26. The generally convex surface of the bowl portion 26 and the surface of the annular flange 24 that is contiguous with that convex surface together define the first mating surface 28. The bowl portion 26 has an internal surface 30 that defines an internal cavity 32. The second formed pulp pre-form 22 similarly has an annular flange 34 that extends around the rim of a bowl portion 36. The second formed pulp pre-form 22 has a second mating surface 38 that, in this example, is defined by the generally concave surface of the bowl portion 36 and the upper surface of the annular flange 34. The bowl portion 36 also defines an internal cavity 40. The second pulp fibre pre-form 22 has an outer major surface 42 that is opposite the second mating surface 38.

FIGS. 2 and 3 correspond with stages within the assembling step 16. In FIG. 2, the second pulp fibre pre-form 22 is being assembled onto the first pulp fibre pre-form 20. In this example, this involves orienting the first and second pulp fibre pre-forms 20, 22 with the first and second mating surfaces 28, 38 facing one another; and lowering the second pulp fibre pre-form 22 onto the first pulp fibre pre-form 20, such that the bowl portion 26 of the first pulp fibre pre-form 20 is received in the internal cavity 40 of the second pulp fibre pre-form 22.

FIG. 3 shows the first and second pulp fibre pre-forms 20, 22 once the assembly step 16 is complete. In FIG. 3, the first and second mating surfaces 28, 38 are substantially in contact with one another.

FIG. 4 shows schematically a pulp fibre laminate 44 formed following the step 18 of bonding the assembled first and second pulp fibre pre-forms 20, 22 to one another. The pulp fibre laminate 44 has annular flange 46 that extends around the rim of a bowl portion 48. The annular flange 46 is formed of the bonded annular flanges 24, 34, and the bowl portion 48 is formed of the bonded bowl portions 26, 36. The internal surface 30 and cavity 32 of the first pulp fibre pre-form 20 is carried through to the pulp fibre laminate 44, notwithstanding the bonding step 18. Similarly, the outer major surface 42 of the second pulp fibre pre-form 22 is carried through to the pulp fibre laminate 44, notwithstanding the bonding step 18.

It will be appreciated that the bonding step 18 is likely to involve deformation of the first and second pulp fibre pre-forms 20, 22. This is particularly likely to occur where the bonding step 18 involves applying mechanical pressure to the pre-forms 20, 22, such as between opposing surfaces of the toolset of a press. The extent of deformation will at least partly depend on the initial shapes of the pre-forms 20, 22 and the shapes of the tools within the press.

As will be apparent from FIGS. 2 and 3, each of the first and second mating surfaces 28, 38 is non-planar. In this particular embodiment, the first and second mating surfaces 28, 38 are shaped so that the first pulp fibre pre-form 20 nests completely within the second pulp fibre pre-form 22. More particularly, the first and second mating surfaces 28, 38 in the example shown in in FIGS. 2 and 3 fully complement one another.

The method 10 has the advantage that the pre-forms 20, 22 can be formed from suspensions of pulp fibres in liquids having different characteristics that give rise to differing characteristics in the laminae of the pulp fibre laminate 44 produced by the method 10. Consequently, the pulp fibre laminate 44 (and thus also the moulded pulp fibre product) can have the benefit of those differing characteristics in its laminae.

The production time for a moulded pulp fibre product is at least in part a function of the wall thickness of that product. Further, that function relates the production time to the wall thickness, involving an exponential of the wall thickness with the exponent being positive and greater than 1. Thus, the method 10 can also provide the advantage of enabling a faster production rate for a moulded pulp fibre product that is a laminate of two or more pulp pre-forms and has a nominal wall thickness, when compared with a moulded pulp fibre product having the same nominal wall thickness and being formed from a single pulp pre-form.

By way of example, the pulp fibre laminate 44 shown in FIG. 4 is shaped to provide a bowl-shaped container with the cavity 32 suitable for storing an aliquot (not shown) of ground coffee. The lamina that is formed from the first pulp fibre pre-form 20 (and thus from the first suspension) can be formed from materials that are suitable for long-term contact with food stuffs, and the lamina that is formed from the second pulp fibre pre-form 22 (and thus from the second suspension) can be formed from materials that are unsuitable for long-term contact with food stuffs, or otherwise considered undesirable for contact with food stuffs, but have desirable air/oxygen impermeability properties. Thus, the pulp fibre laminate 44 can provide a moulded pulp fibre product that can contain food stuffs for an extended period without spoiling.

The first and second suspensions can be formed of differing constituent materials. To this end and depending on the desired properties of the respective lamina, the first and second suspensions can be formed of differing pulp fibres, differing liquid components, and/or additives. In this way, the lamina formed by the first and second suspensions can have different functional and/or aesthetic properties. Alternatively or additionally, the suspensions of the respective lamina may perform differently during the applying sub-steps 12a, 14a and/or the extracting sub-steps 12b, 14b.

In one example, the pulp fibre laminate 44 can have the first pulp pre-form 20 formed from a first suspension that includes cellulose fibres in a liquid water and polyvinyl alcohol (PVA) blend, and the second pulp pre-form 22 formed from a second suspension that includes bagasse fibres in a liquid water and starch blend. Further, the fibres of each of the first and second suspensions can be processed to have differing diameters and/or lengths. In this way, the properties of each of the first and second pulp pre-forms 20, 22 make differing contributions to the overall properties of the pulp fibre laminate 44.

Further, it may be desirable for the pulp fibre laminate 44 to visually indicate the particular ground coffee aliquot that will ultimately be stored within the bowl portion 48. To provide this visual indication, an additive, in the form of a coloured dyes or pigmented matter, within the second suspension will colour the second pulp pre-form 22 that is discernible externally of the pulp fibre laminate 44.

By way of example only, the second pulp pre-form 22 may include shredded coffee husk, which will ultimately be visible in the outer major surface 42 of the pulp fibre laminate 44. The visible coffee husk material includes pigments that assist consumers in identifying qualities, characteristics, etc. of the final moulded pulp fibre product.

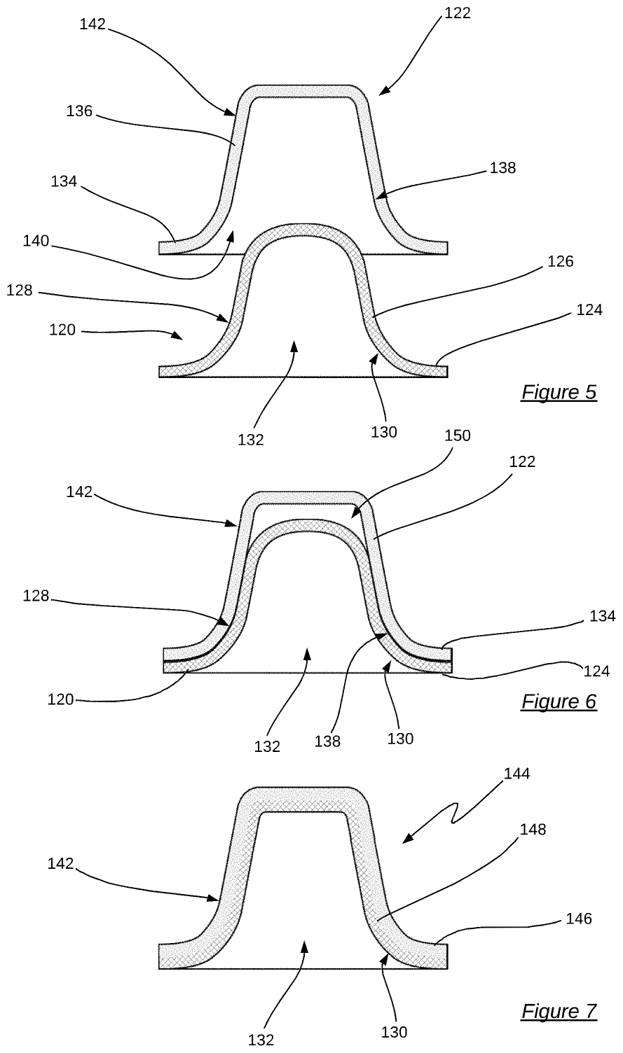

FIGS. 5 to 7 further illustrate schematically stages in the method 10, according to a second example. In FIGS. 5 and 6, a formed first pulp pre-form 120 and a formed second pulp pre-form 122 are shown. The first pulp pre-form 120 has an annular flange 124 that extends around the rim of a bowl portion 126. The generally convex surface of the bowl portion 126 and the surface of the annular flange 124 that is contiguous with that convex surface together define the first mating surface 128. The bowl portion 126 has an internal surface 130 that defines an internal cavity 132. The second formed pulp pre-form 122 similarly has an annular flange 134 that extends around the rim of a bowl portion 136. The second formed pulp pre-form 122 has a second mating surface 138 that, in this example, is defined by the generally concave surface of the bowl portion 136 and the upper surface of the annular flange 134. The bowl portion 136 also defines an internal cavity 140. The second pulp fibre pre-form 122 has an outer major surface 142 that is opposite the second mating surface 138.

It will be readily apparent from a comparison of FIGS. 2 and 5 (and also FIGS. 3 and 6) that in the embodiment of FIGS. 5 to 7, the first and second mating surfaces 128, 138 are shaped so that when the first pulp fibre pre-form 120 is nested within the second pulp fibre pre-form 122 (as shown in FIG. 6) there is an interstitial cavity 150 between the two mating surfaces 128, 138. Thus, in the forming steps 12, 14 of this particular example, the first and second mating surfaces 128, 138 only partially complement one another.

FIG. 6 shows the first and second pulp fibre pre-forms 120, 122 once the assembling step 16 is complete. FIG. 7 shows schematically a pulp fibre laminate 144 formed following step 18, in which the assembled first and second pulp fibre pre-forms 120, 122 are bonded to one another. As will be appreciated, in this example of the method, during the bonding step 18, the first pulp pre-form 120 is deformed so as to eliminate the interstitial cavity 150. The interstitial cavity 150 may be eliminated by movement of one or both of the first and second pulp fibre pre-forms 120, 122 that drives gas into/through the pre-forms 120, 122.

The pulp fibre laminate 144 has annular flange 146 that extends around the rim of a bowl portion 148. The annular flange 146 is formed of the bonded annular flanges 124, 134, and the bowl portion 148 is formed of the bonded bowl portions 126, 136. The above-described deformation of the first pulp pre-form during the bonding step 18 causes surfaces of bowl portion 126 to adopt a shape that generally corresponds with the second mating surface 138, having regard to the thickness of the lamina in the pulp fibre laminate 144 that is derived from the first pulp pre-form 120. Thus, the bonding step 18, while the outer major surface 142 of the second pulp fibre pre-form 122 is carried through to the pulp fibre laminate 144, the general shape of the second mating surface 138 is translated to the internal surface 140 of the bowl portion 148.

Embodiments of the method 10 in which the first and second mating surface only partially complement each other may be desirable where one or more of the pulp pre-forms has a high moisture content prior to the completion of the bonding step. In such instances, the high moisture content can result in uncontrolled deformation during the assembling step 16. It will be appreciated that retaining an interstitial cavity 150 (or multiple interstitial cavities) prior to the bonding step 18 can facilitate greater control in the wall thickness of the laminae in the final pulp fibre laminate.

FIG. 8 is a flowchart illustrating a method 210 of forming a moulded pulp fibre product, the method 210 being in accordance with a second embodiment. The method 210 has steps that are similar to steps of the method 10 described and illustrated in FIG. 1. Those similar steps have the same reference numerals with the prefix “2”.

In the method 210 illustrated in FIG. 8, forming step 212 involves two sub-steps 212a, 212b; in applying sub-step 212a, a first suspension of pulp fibres in liquid is applied to a first porous mould portion to form a first slurry deposit on the first mould portion. The method 210 differs from method 10 in that sub-step 212b, involves drying the first slurry deposit, such that fluid is removed from the first suspension whilst remaining on the first porous mould portion. The drying step 212b may involve partial drying of the first suspension such that a first pulp pre-form is created that has sufficient internal strength to be transferred in the assembling step 216 that follows.

Heating the first slurry deposit can involve any one or more of: directing heated air towards the second slurry deposit, exposing the first slurry deposit to radiant heat, heating the first porous mould portion, and directing microwave and/or ultrasound energy towards the first slurry deposit. By the selected heating action, the first slurry deposit is dried to form the first pulp pre-form as a “green part”.

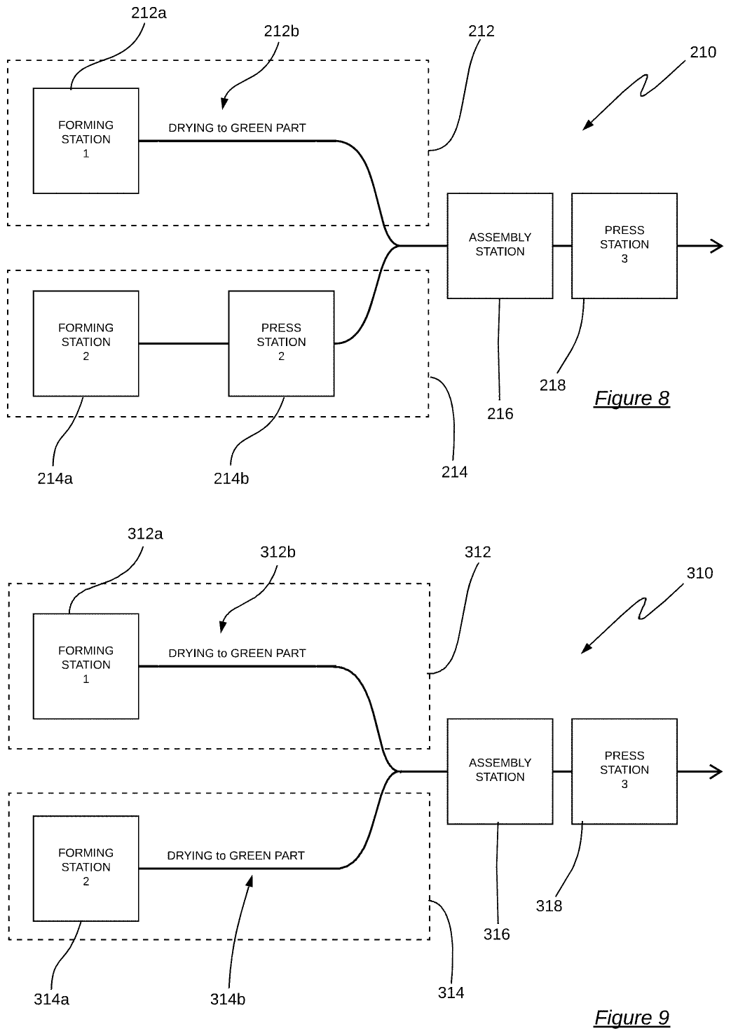

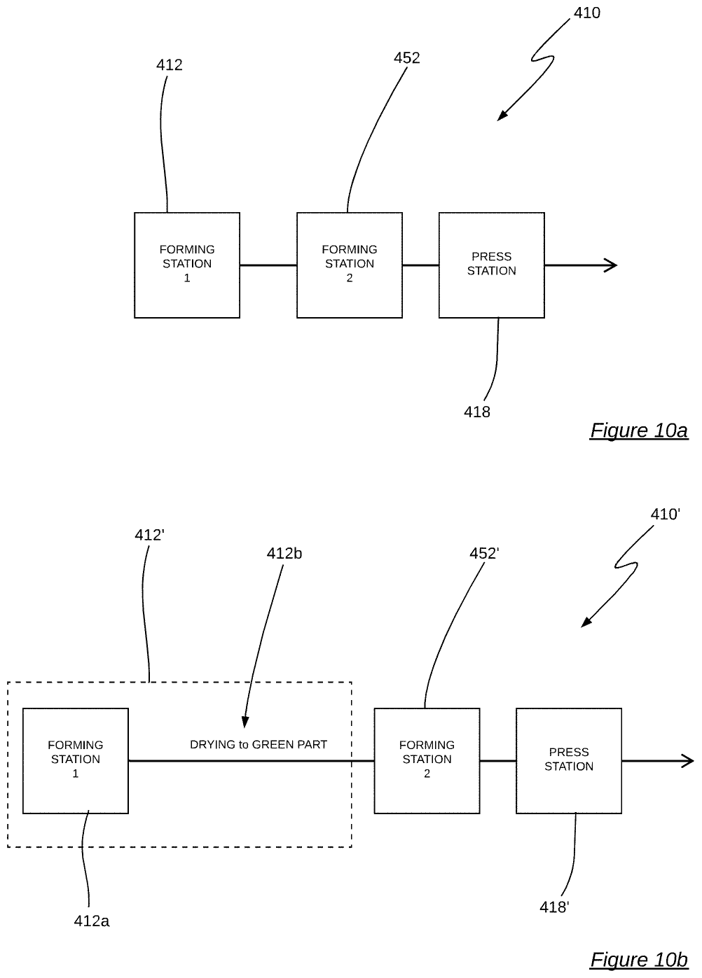

FIG. 9 is a flowchart illustrating a method 310 of forming a moulded pulp fibre product, the method 310 being in accordance with a third embodiment. The method 310 has steps that are similar to steps of the method 10 described and illustrated in FIG. 1. Those similar steps have the same reference numerals with the prefix “3”.

In the method 310 illustrated in FIG. 9, both forming steps 312, 314 involves two sub-steps 312a, 312b, and 314a, 314b respectively. In applying sub-steps 312a, 314a, the first and second suspensions of pulp fibres in liquid are applied to first and second porous mould portions, respectively forming first and slurry deposits on the first and second mould portions. The method 310 differs from method 10 in that both sub-steps 312b, 314b involve drying the first and second slurry deposits to form two “green parts” prior to the assembling step 316. Sub-steps 312b, 314b are substantially similar to sub-step 212b described above in reference to FIG. 8.

FIG. 10a is a flowchart illustrating a method 310 of forming a moulded pulp fibre product, the method 310 being in accordance with a fourth embodiment. The method 310 has steps that are similar to steps of the method 10 described and illustrated in FIG. 1. Those similar steps have the same reference numerals with the prefix “4”.

In the method 410 illustrated in FIG. 10a, forming step 412 involves applying a first suspension of pulp fibres in liquid to a first porous mould portion to form a first slurry deposit on the first mould portion. At step 452, a second pulp fibre pre-form is formed (from a suspension of pulp fibres in liquid) directly onto the first pulp pre-form. To this end, a second suspension of pulp fibres in liquid is applied to the first pulp pre-form, forming a second slurry deposit directly on the first slurry deposit.

In one example, the first pulp pre-form can be retained on the first porous mould portion, and the second suspension of pulp fibres in liquid is applied onto the exposed surface of the first pulp pre-form, thereby forming the second pulp fibre pre-form on the first pulp fibre pre-form.

In one example, step 452 may be achieved by process steps for forming a pre-form for a moulded pulp fibre product that are described and illustrated in the Applicant's International Patent Application PCT/AU2020/050039 (which claims priority from Australian Patent Application No. 2019900218), the disclosure of which is incorporated herein by reference.

In the embodiment of FIG. 10a, the upper surface of the first pulp fibre pre-form forms the first mating surface. As the formation of the second pulp fibre pre-form and the assembling of the first and second pulp fibre pre-forms occurs concurrently and contiguously within step 452, the second mating surface is formed in situ during step 452. Thus, in this method 410, the steps 412, 452 of forming the first and second pulp pre-forms, and assembling the first and second pulp pre-forms overlap with another. In particular, the step of forming the first pulp pre-form is only partially completed when the step of forming the second pulp pre-form commences. Further, the step of forming the second pulp pre-form occurs concurrently with the step of assembling the first and second pulp pre-forms.

The method 410 further involves step 418, in which the first and second pulp fibre pre-forms are bonded to one another, thereby forming a pulp fibre laminate. In this example, step 418 involves application of at least pressure to the assembled first and second pulp fibre pre-forms in a press—“Press Station” in FIG. 10. Step 418 is substantially similar to step 18 of the embodiment in FIG. 1.

FIG. 10b illustrates the steps of a method 410′ that is a variant of the method 410 that is illustrated in FIG. 10a. In method 410′, the forming step 412′ involves two sub-steps 412a, 412b. In an applying sub-step 412a, a first suspension of pulp fibres in liquid is applied to a first porous mould portion to form a first slurry deposit on the first mould portion. Method 410′ involves an additional sub-step 412b in which the first slurry deposit is partially dried (indicated by “Drying to Green Part”), such that some fluid is removed from the first suspension prior to the second pulp pre-form being formed on the first pulp pre-form. Where included, sub-step 412b is substantially similar to sub-step 212b described above in reference to FIG. 8. Drying of the first slurry deposit in sub-step 412b may provide the benefit of the first pulp pre-form having reduced pulp fibre mobility, such that the combined steps of forming the second pulp pre-form from the second suspension and assembling the second pulp pre-form onto the first pulp pre-form is less disruptive to the first pulp pre-form.

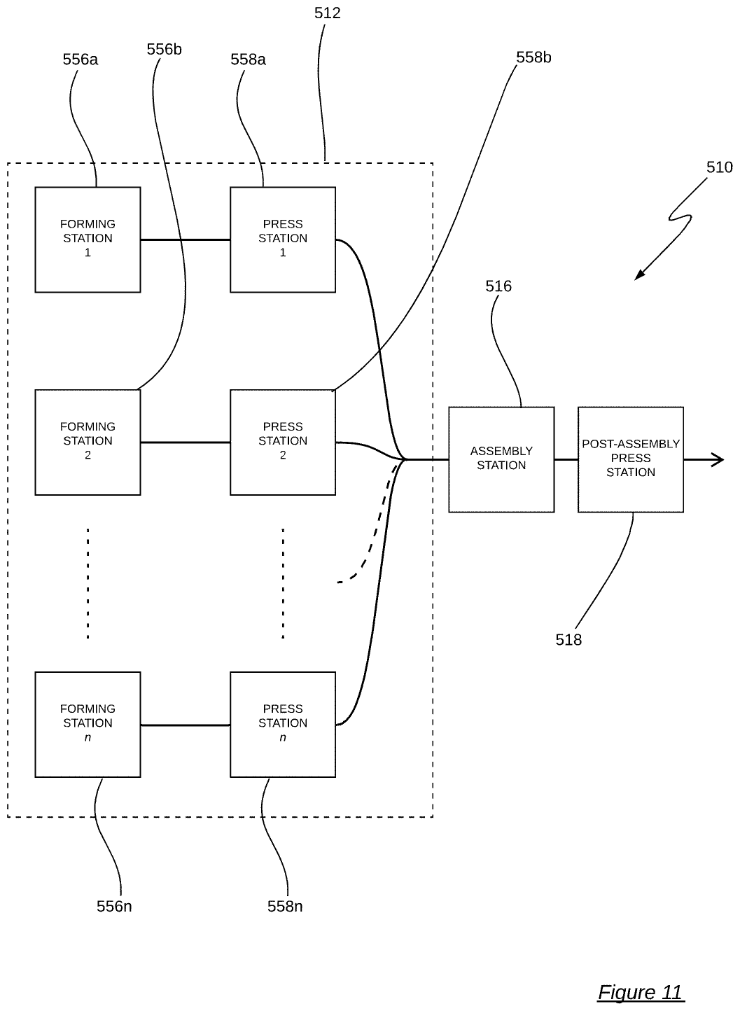

FIG. 11 is a flowchart illustrating a method 510 of forming a moulded pulp fibre product, the method 10 being in accordance with a first embodiment. The method 510 of this embodiment involves:
Forming a number of pulp fibre pre-forms that each include at least one mating surface, and each pre-form being made from a suspension of pulp fibres in liquid—step 512.
Assembling the pulp fibre pre-forms into a set in which adjacent pulp fibre pre-forms have mating surfaces that are in contact with, or adjacent to one another—step 516.
Bonding the set of pulp fibre pre-forms to one another, thereby forming a pulp fibre laminate from the set—step 518.

It will be apparent from FIG. 11 that in this example there are n pulp fibre pre-forms, in which n is a number that is 3 or higher. Consequently, in the set of pulp fibre pre-forms that are assembled in step 516 there will be (n−2) intermediate pulp fibre pre-forms between the first and nth pulp fibre pre-forms on opposing ends of the set, respectively.

As with bonding step 18 (of the method 10), bonding step 518 of this method 510 involves application of at least pressure to the assembled first and second pulp fibre pre-forms in a press—“Post-Assembly Press Station” in FIG. 11. The application of pressure can be augmented with heat to facilitate liberation of liquid from the pre-forms, and/or with suction to facilitate drawing of fluid from the pre-forms. As forming step 512 of the method 510 forms n pulp fibre pre-forms, the pulp fibre laminate will have n laminae, of which the 1^{st} and the n^{th} laminae will have external surfaces of the pulp fibre laminate. The pulp fibre laminate will have (n−2) laminae between the 1^{st} and the n^{th} laminae.

In the method 510 illustrated in FIG. 11, the forming step 512 involves, for each pulp fibre pre-form:
Applying a suspension of pulp fibre in liquid to a porous mould portion to form a slurry deposit on the mould portion—sub-steps 556a, 556b, 556n.
Extracting fluid from the slurry deposit through the porous mould portion to form the pulp fibre pre-form—sub-steps 558a, 558b, 558n.
Sub-steps 556a, 556b, 556n can occur within forming stations—“Forming Station 1”, etc. in FIG. 11; and are substantially similar to sub-step 12a of the method 10. Sub-steps 558a, 558b, 558n can involve application of pressure to the respective slurry deposit within a mechanical press—“Press Station 1”, etc. in FIG. 11; and are substantially similar to sub-step 12b of the method 10.

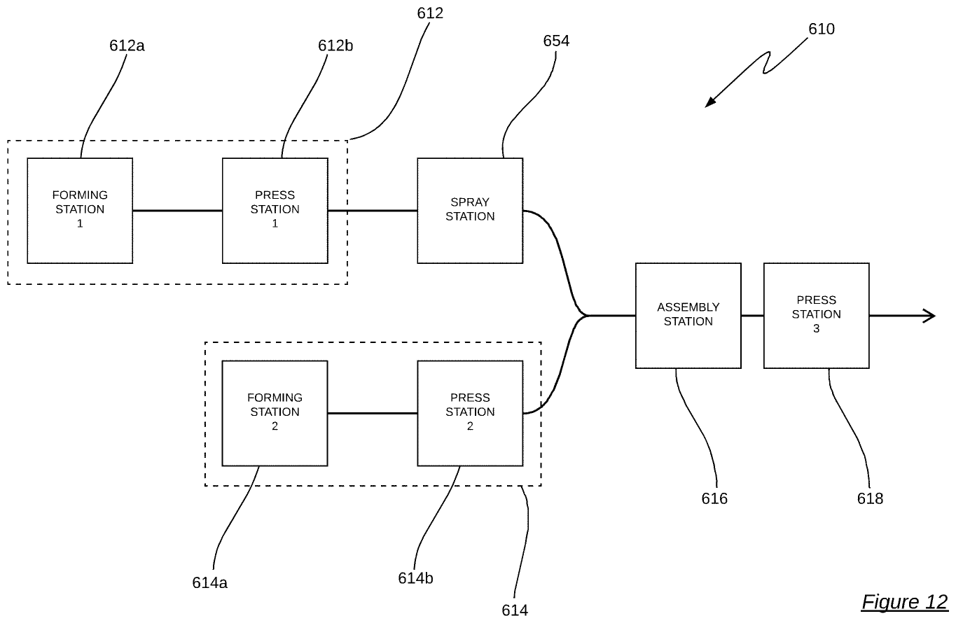

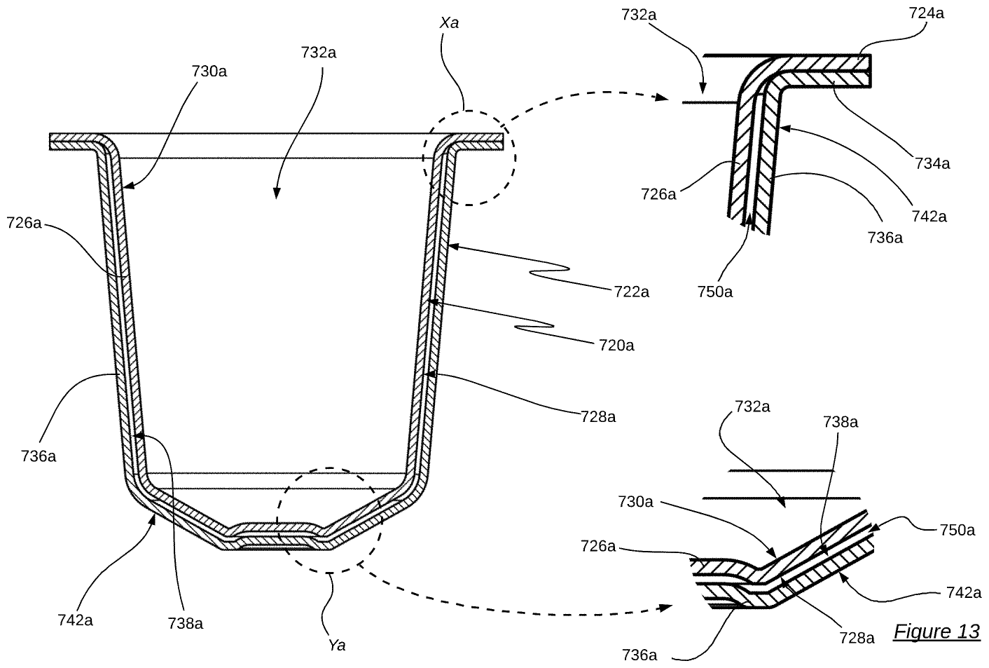

FIG. 12 is a flowchart illustrating a method 610 of forming a moulded pulp fibre product, the method 610 being in accordance with a second embodiment. The method 610 has steps that are similar to steps of the method 10 described and illustrated in FIG. 1. Those similar steps have the same reference numerals with the prefix “6”.

Method 610 differs from method 10 in that it includes an additional step 654 within forming step 612. Step 654 involves applying a curable materials to the first mating surface of the first pulp fibre pre-form prior to the assembling step, the curable materials operating to form chemical bonds between adjacent pulp fibre pre-forms.

In one example, a heat activated adhesive in a liquid form may be applied by a set of spray heads—“Spray Station” in FIG. 12—that direct a spray of the adhesive onto the first mating surface of the first pulp pre-form. The first and second pulp pre-forms are assembled in assembling step 616, and the assembled pair of pre-forms are then bonded to one another in bonding step 618, thereby forming a pulp fibre laminate.

In another example, curable materials can be applied in step 654 that form a layer between the pulp fibre laminae of the pulp fibre laminate, the additional layer providing a barrier to gas or liquid propagating through the pulp fibre laminate. For instance, a liquid with highly refined fibres, such as highly refined cellulose fibres and/or cellulose nano-fibres, can be applied in a spray via the set of spray heads onto the slurry deposit of the first pulp pre-form. In this way, a chemical and/or nano-fibre interlayer can be formed between the laminae from the first and second pulp pre-forms. As will be appreciated, the interlayer in a pulp fibre laminate that is formed by this embodiment will not be part of a contact surface in the final pulp fibre laminate.

Bonding step 618 of this method 610 involves application of heat and pressure to the assembled first and second pulp fibre pre-forms in a press—“Press Station 3” in FIG. 12. The application of heat has the effect of activating the liquid adhesive, which facilitate formation of chemical bonds between the laminae of the pulp fibre laminate.

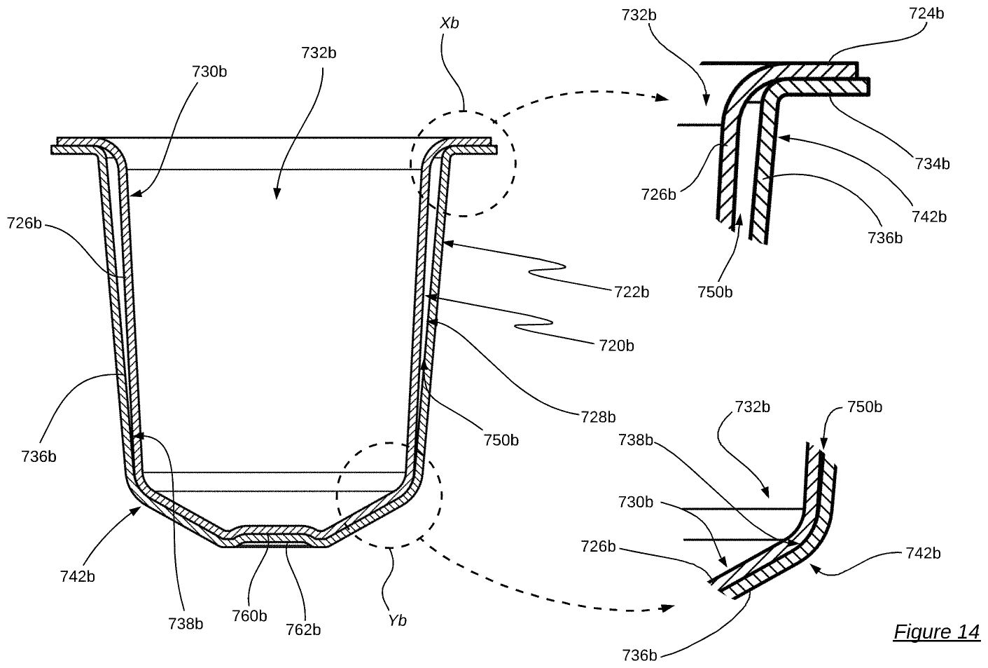

FIG. 13 is a vertical cross-sectional view of first and second pulp fibre pre-forms 720a, 722a according to a third example. In the context of the method 510 described in connection with FIG. 11, FIG. 13 illustrates the pulp fibre pre-forms 720a, 722a are assembled into a set (following completion of step 516), and ready for bonding to one another according to step 518 to form a pulp fibre laminate.

The first pulp pre-form 720a has an annular flange 724a that extends around the rim of a bowl portion 726a. A first mating surface 728a is defined by the generally convex surface of the bowl portion 726a and the surface of the annular flange 724a that is contiguous with that convex surface. The bowl portion 726a has an internal surface 730a that defines an internal cavity 732a.

The second pulp pre-form 722a similarly has an annular flange 734a that extends around the rim of a bowl portion 736a. The second formed pulp pre-form 722a has a second mating surface 738a that, in this example, is defined by the generally concave surface of the bowl portion 736a and the upper surface of the annular flange 734a. The second pulp fibre pre-form 722a has an outer major surface 742a that is opposite the second mating surface 738a.

In this example, outer major surface 742a will become the external surface of the bowl of the final pulp fibre laminate. Further, internal surface 730a and internal cavity 732a will become the internal surface and cavity of the bowl of the final pulp fibre laminate.

The first and second pulp pre-forms 720a, 722a are shaped so that mating surfaces 728a, 738a only partially complement each other. As shown in enlarged Regions Xa and Ya of FIG. 13, mating surfaces 728a, 738a in the assembled set of pulp fibre pre-forms contact one another at the annular flanges 724a, 734a. Prior to bonding, the bowl portions 726a, 736a are spaced from one another, such that an interstitial cavity 750a is formed therebetween.

As will be appreciated particularly from enlarged Region Xa of FIG. 13, the first pulp pre-form 720a has a larger radius in its transition from the annular flange 724a to the bowl portion 726a, when compared with the corresponding features of the second pulp pre-form 722a. Outside of the regions of transition, the separation of the first and second mating surfaces 728a 738a (in mutually normal directions) is substantially equal.

During the bonding step 518 of the method 510 as applied to the first and second pulp pre-forms 720a, 722a, the side wall and base of the bowl portion 726a of the first pulp pre-form 720a will be deformed. To this end, the side wall and base of the bowl portion 726a will be displaced radially outwardly and longitudinally (with respect to the central axis of symmetry) to bring the first mating surface 726a to fully contact the second mating surface 736a. It will be appreciated that in practice it is likely that there will also be deformation of the side wall and base of the bowl portion 736a of the second pulp pre-form 722a, involving inward movement towards bowl portion 726a. In this way, the interstitial cavity 750a will be eliminated.

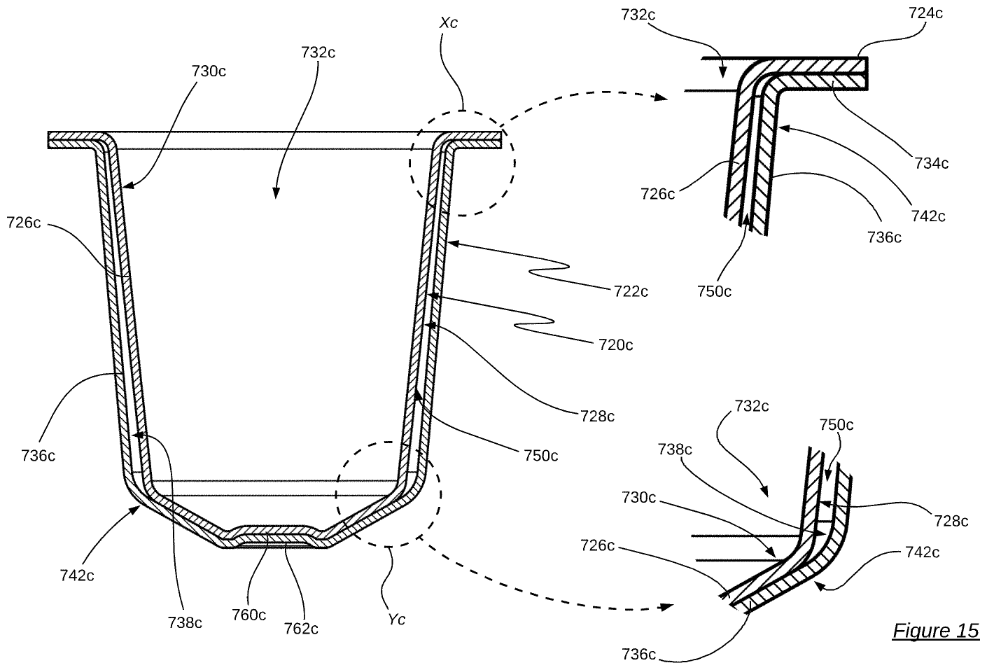

FIGS. 14 and 15 are similar vertical cross-sectional views of first and second pulp fibre pre-forms. In FIGS. 14 and 15, the first pulp fibre pre-forms are labelled 720b and 720c respectively, and the second pulp fibre pre-forms are labelled 722b and 722c respectively. The first pulp fibre pre-forms 720b, 720c and second pulp fibre pre-forms 722b, 722c have features and component parts similar to those described and illustrated in FIG. 13. Those similar features and component parts have the same reference numerals with the suffix “a” replaced with “b” and “c” in FIGS. 14 and 15 respectively.

With respect to the example shown in FIG. 14, the first and second pulp pre-forms 720b, 722b are also shaped so that mating surfaces 728b, 738b only partially complement each other. As shown in enlarged Regions Xb and Yb of FIG. 14, mating surfaces 728b, 738b in the assembled set of pulp fibre pre-forms are in contact with one another at the annular flanges 724b, 734b, and also at the base of the bowl portions 726b, 736b.

The bases of the bowl portions 726b, 736b are shaped such that the mating surfaces 728b, 738b complement each other. In particular, the base of bowl portion 726b includes a dimple formation 760b, and the base of bowl portion 736b also includes a dimple formation 762b.

Prior to bonding, the side walls of the bowl portions 726b, 736b are spaced from one another, such that an interstitial cavity 750b is formed therebetween. Further, the side wall of the bowl portion 726b of the first pulp pre-form 720b has a draft angle that is less than that of the side wall of the bowl portion 736b of the first pulp pre-form 722b. The width of the interstitial cavity 750b decreases in a direction away from the annular flanges 724b 734b.

It will be appreciated that the differing draft angles and complementing mating surfaces 728b, 738b within the base of the bowl portions 726b, 736b can provide the benefit of facilitating the assembling step 516. To this end, the first and second pulp pre-forms 720b, 722b can be brought into axial alignment during the assembling step 516, with the dimple formations 760b, 762b aiding in this alignment. The differing draft angles aiding in mitigating contact of the side walls of the bowl portions 726b, 736b with one another that may disrupt the fibres in the pre-forms.

It is also relevant to observe, particularly from Region Xb, that the diameter of the annular flange 724b of the first pulp pre-form 720b is smaller than that of the annular flange 734b of the second pulp pre-form 722b. Further, the first pulp pre-form 720b has a larger radius in its transition from the annular flange 724b to the bowl portion 726b, when compared with the corresponding features of the second pulp pre-form 722b.

During the bonding step 518 of the method 510 as applied to the first and second pulp pre-forms 720b, 722b, both the annular flange 724b and the side wall of the bowl portion 726b of the first pulp pre-form 720b will be deformed. To this end, the annular flange 724b and the side wall of the bowl portion 726b will be displaced radially outwardly (with respect to the central axis of symmetry) to bring the first mating surface 726b to fully contact the second mating surface 736b. It will be appreciated that in practice it is likely that there will also be deformation of the side wall of the bowl portion 736b of the second pulp pre-form 722b, involving inward movement towards bowl portion 726b. In this way, the interstitial cavity 750b will be eliminated.

With respect to the example shown in FIG. 15, the first and second pulp pre-forms 720c, 722c are also shaped so that mating surfaces 728c, 738c only partially complement each other. As shown in enlarged Regions Xc and Yc of FIG. 15, mating surfaces 728c, 738c in the assembled set of pulp fibre pre-forms are in contact with one another at the annular flanges 724c, 734c, and also at the base of the bowl portions 726c, 736c.

The bases of the bowl portions 726c, 736c are shaped such that the mating surfaces 728c, 738c complement each other. In particular, the base of bowl portion 726c includes a dimple formation 760c, and the base of bowl portion 736c also includes a dimple formation 762c.

The first pulp pre-form 720c has a larger radius in its transition from the annular flange 724c to the bowl portion 726c, when compared with the corresponding features of the second pulp pre-form 722c. This difference is evident in the first and second pulp pre-forms 720c, 722c, as shown in enlarged Region Xc.

As particularly shown in enlarged Region Yc, the first pulp pre-form 720c has a smaller radius in its transition from the side wall to the base of the bowl portion 726c, when compared with the corresponding features of the second pulp pre-form 722c.

Prior to bonding, the side walls of the bowl portions 726c, 736c are spaced from one another, such that an interstitial cavity 750c is formed therebetween. The side wall of the bowl portion 726c of the first pulp pre-form 720c has a draft angle that is greater than that of the side wall of the bowl portion 736c of the first pulp pre-form 722c. Consequently, the separation of the first and second mating surfaces 728c, 738c within the side walls of the bowl portions 726c, 736c increases from the annular flanges 724c, 734c in a direction towards the bases. In other words, the interstitial cavity 750c is generally annular in shape, and the difference between the internal and external radii of the interstitial cavity increases from the annular flanges 724, 734 in a direction towards the bases.

It will be appreciated that the differing draft angles facilitate the insertion of the first pulp pre-form 720c into the internal cavity 742c of the second pulp pre-form 722c (during the assembling step 516). The complementing mating surfaces 728c, 738c within the annular flanges 724c, 734c and the base of the bowl portions 726c, 736c provide the benefit of facilitating axial alignment of the two pre-forms during the assembling step 516. To this end, the first and second pulp pre-forms 720c, 722c can be brought into axial alignment, whilst avoiding contact of the side walls of the bowl portions 726c, 736c with one another that disrupt the fibres in the pre-forms.

During the bonding step 518 of the method 510 as applied to the first and second pulp pre-forms 720c, 722c, the side wall of the bowl portion 726c of the first pulp pre-form 720c will be deformed. To this end, the side wall of the bowl portion 726c will be displaced radially outwardly (with respect to the central axis of symmetry) to bring the first mating surface 726c to fully contact the second mating surface 736c. It will be appreciated that in practice it is likely that there will also be deformation of the side wall of the bowl portion 736c of the second pulp pre-form 722c, involving inward movement towards bowl portion 726c. In this way, the interstitial cavity 750c will be eliminated.

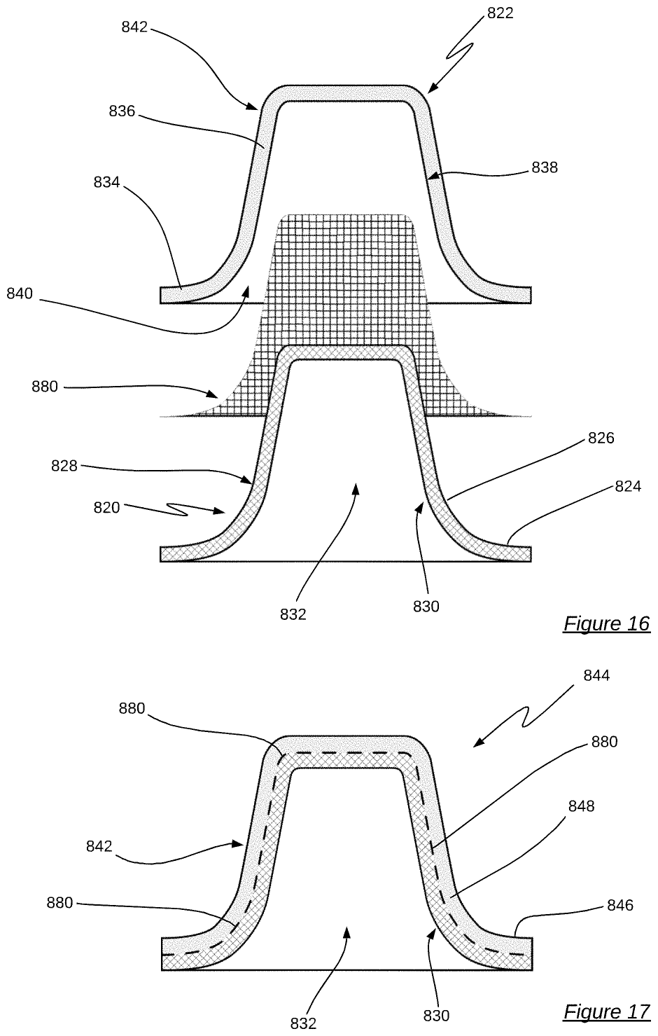

FIGS. 16 and 17 illustrate schematically stages in a method of forming a moulded pulp fibre product, the method being substantially similar to the method 10 of the first embodiment.

In FIG. 16, a formed first pulp pre-form 820 and a formed second pulp pre-form 822 are shown schematically, and this figure corresponds with a stage within the assembling step. FIG. 17 shows schematically a pulp fibre laminate 844 formed following the step of bonding the assembled first and second pulp fibre pre-forms 820, 822 to one another.

Parts and features of each of the first and second pulp pre-forms 820, 822, and the pulp fibre laminate 844 that are the same or similar to parts and features of the first and second pulp pre-forms 20, 22, and the pulp fibre laminate 44 (illustrated in FIGS. 2 to 4) have the same reference numbers with the prefix “8”, and for succinctness will not be described again.

In the method illustrated by FIGS. 16 and 17, an interstitial layer 880 is incorporated between the first and second pulp pre-forms 820, 822. The interstitial layer 880 is made of a fibrous material.

In the final pulp fibre laminate 844, the interstitial layer 880 is bonded within the pulp fibre materials. Consequently, load is transferred between the pulp fibre material and the material of the interstitial layer. The interstitial layer 880 distributes tensile and shear stress, such that the ability of the pulp fibre laminate 844 to retain its integrity when subjected to working loads is improved. To this end, the interstitial layer 880 can enable the pulp fibre laminate 844 to support positive pressures within the internal cavity 832 without rupturing. In this example, the inclusion of the interstitial layer 880 improves the ability of the pulp fibre laminate 880 to support hoop and longitudinal stresses generated by the positive internal pressure.

The interstitial layer 880 is preferably made of a non-synthetic material, so that the biodegradability and/or compostability of the pulp fibre laminate 844 is not compromised by the inclusion of the interstitial layer. In some examples, the interstitial layer 880 can include fibres made from plant material (such as linen, hemp, cotton, coir, bamboo etc.), animal protein-based fibres, and mineral fibre (such as mineral wool). The interstitial layer 880 can include filament fibres that are made artificially from biological processes. Further, the interstitial layer 880 can be a blend fibres from two or more sources.

In this example, the material of the interstitial layer 880 is an open weave material, which allows the pulp fibres in the first and second pulp pre-forms 820, 822 to form bonds that extend through the interstitial layer 880 during the bonding step of the method.

To facilitate the assembling step involving the first and second pulp pre-forms 820, 822 and the interstitial layer 880, the interstitial layer may have a shaped form that corresponds (at least partially) with one or both of the mating surfaces 828, 838. Alternatively or additionally, prior to the assembling step, the interstitial layer 880 can be soaked in liquid to facilitate the material conforming to the shape of the surfaces 828, 838.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-66. (canceled)

67. A method of forming a moulded pulp fibre product, the method involving:
forming two or more pulp fibre pre-forms that each include at least one mating surface, each pre-form being made from a suspension of pulp fibres in liquid;
assembling the pulp fibre pre-forms into a set in which adjacent pulp fibre pre-forms have mating surfaces that are in contact with, or adjacent to one another; and
bonding the set of pulp fibre pre-forms to thereby form a pulp fibre laminate.

68. The method according to claim 67, wherein the step of bonding the set of pulp fibre pre-forms involves applying at least one of heat and pressure to the assembled set of pulp fibre pre-forms.

69. The method according to claim 67, wherein step of bonding the set of pulp fibre pre-forms involves creating mechanical bonds between adjacent pulp fibre pre-forms in the set.

70. The method according to claim 67, further involving forming the pulp fibre pre-forms that are to be adjacent one another in the set with mating surfaces that fully complement one another.

71. The method according to claim 67, further involving forming the pulp fibre pre-forms that are to be adjacent one another in the set with mating surfaces that only partially complement one another, and at least one of the assembling and bonding steps involves deforming at least one of the pulp fibre pre-forms in the set.

72. The method according to claim 67, further involving creating two or more suspensions of pulp fibres in liquid, at least one of the pulp fibre pre-forms being formed of a first of the suspensions, and at least one of the pulp fibre pre-forms being formed of a second of the suspensions, and
wherein the pulp fibres used in each of the first and second suspensions are selected to have differing characteristics,
the liquid components of the first and second suspensions have differing substances dissolved and/or dispersed within the respective liquid component,
the liquid component of the first suspension and/or the second suspension includes substances that are not present in the liquid component of the other suspension, and/or
the first and/or second suspension has additives that alter the visual appearance of the respective lamina in the moulded pulp fibre product.

73. The method according to claim 72, further involving creating two or more suspensions of pulp fibres in liquid, at least one of the pulp fibre pre-forms being formed of a first of the suspensions, and at least one of the pulp fibre pre-forms being formed of a second of the suspensions,
wherein the liquid components of the first and second suspensions have differing substances dissolved and/or dispersed within the respective liquid component, and
wherein substances within at least one of the suspensions undergo a chemical reaction with one another and/or with the pulp fibre component of the respective suspension, such that the laminae in the moulded pulp fibre product have differing properties; and/or
substances within at least one of the suspensions bond with the pulp fibres as the respective suspension dries, and wherein in the moulded pulp fibre product the solutes in the respective lamina contribute to the laminae in the moulded pulp fibre product having differing properties.

74. The method according to claim 72, wherein for each pulp fibre pre-form, the forming step involves:
applying the suspension to a porous mould portion to form a slurry deposit on the mould portion; and
extracting fluid from the slurry deposit through the porous mould portion to form the pulp fibre pre-form.

75. The method according to claim 74, wherein the step of extracting fluid is such that, when assembling the pulp fibre pre-forms into the set, at least one of the pulp fibre pre-forms has a residual moisture content.

76. The method according to claim 74, wherein for each pulp fibre pre-form, the step of extracting fluid from the slurry deposit involves heating the slurry deposit to thereby cause at least some liquid within the slurry deposit to change to gas, and
wherein heating the slurry deposit involves any one or more of:
directing heated air towards the slurry deposit, exposing the slurry deposit to radiant heat, heating the porous mould toolset, and directing microwave and/or ultrasound energy towards the slurry deposit.

77. The method according to claim 74, wherein for each pulp fibre pre-form, the step of extracting fluid from the respective slurry deposit involves positioning a conformable material on the surface of that slurry deposit such that the slurry deposit is between the porous mould portion and the conformable material, and, when the conformable material is in contact with the slurry deposit, applying a pressure differential across the slurry deposit so as to draw the conformable material towards the porous mould portion and thereby squeeze the slurry deposit between the conformable material and the porous mould portion.

78. The method according to claim 77, wherein the porous mould portion for each pulp fibre pre-form has a mould surface that defines a surface of the respective pulp fibre pre-form.

79. The method according to claim 73, further involving incorporating one or more interstitial layers between two adjacent pulp fibre pre-forms in the set,
wherein each interstitial layer is formed of material that does not include pulp fibres.

80. The method according to claim 79, wherein the interstitial layer has a shaped form corresponding with at least one surface that at least partially corresponds with one of the mating surfaces.

81. The method according to claim 79, further involving forming the interstitial layer in situ on one of the pulp fibre pre-forms.

82. The method according to claim 79, wherein the interstitial layers are inserted between pulp fibre pre-forms prior to the assembling step.

83. The method according to claim 79, wherein the interstitial layers are inserted between pulp fibre pre-forms during the assembling step.

84. The method according to claim 73, further involving applying one or more curable materials to at least one of the mating surfaces prior to the assembling step, the curable materials operating to form chemical bonds between adjacent pulp fibre pre-forms.

85. The method according to claim 73, wherein the forming step for at least two adjacent pulp fibre pre-forms in the set involves forming a second of the adjacent pulp fibre pre-forms concurrently with the step of assembling the second of the adjacent pulp pre-forms with respect to the first of the adjacent pulp pre-forms.

86. A moulded pulp fibre product comprising:
two or more lamina formed of dried pulp fibre materials that are assembled and bonded to form a pulp fibre laminate,
wherein, in the moulded pulp fibre product:
at least two of the laminae have pulp fibres with differing characteristics;
at least one of the lamina includes substances within the lamina that are bonded with the respective pulp fibres, the substances:
having been dissolved and/or dispersed within the liquid component of the suspension from which the lamina is formed, and
causing the respective lamina to have different properties to at least one other lamina in the moulded pulp fibre product; and/or
at least one of the lamina is formed from a suspension that includes additives causing the respective lamina to have a visually different appearance to at least one other lamina in the moulded pulp fibre product.
